(19) United States
(12) Patent Application Publication
(10) Pub. No.: US 2024/0275512 A1
(43) Pub. Date: Aug. 15, 2024

(54) COMMUNICATION CONNECTION DETERMINATION METHOD, COMMUNICATION CONNECTION DETERMINATION DEVICE AND SENSOR SYSTEM

(71) Applicant: Nippon Telegraph and Telephone Corporation, Tokyo (JP)

(72) Inventors: Kenichi Matsunaga, Tokyo (JP); Kento Watanabe, Tokyo (JP)

(21) Appl. No.: 18/565,284

(22) PCT Filed: Jun. 7, 2021
(86) PCT No.: PCT/JP2021/021542

§ 371 Date: Nov. 29, 2023

(51) Int. Cl. H04J 3/06; H04W 4/38; H04W 56/00

(52) U.S. Cl. CPC H04J 3/0661; H04W 4/38; H04W 56/001

(57) ABSTRACT

An embodiment communication connection determination method is a communication connection determination method between a sensor terminal and a sensor accommodating terminal, the method including a step of receiving first data and storing a first time stamp, a step of determining the reception number of pieces of the first data, a step of calculating a mean deviation reference value using a first time stamp interval obtained from the first time stamp, a step of receiving second data and storing a second time stamp, a step of determining the reception number of pieces of the second data, a step of calculating a mean deviation evaluation value using a second time stamp interval obtained from the second time stamp, and a step of testing whether there is a significant difference between the mean deviation reference value and the mean deviation evaluation value.

### CROSS-REFERENCE TO RELATED APPLICATIONS

This application is a national phase entry of PCT Application No. PCT/JP2021/021542, filed on Jun. 7, 2021, which application is hereby incorporated herein by reference.

### TECHNICAL FIELD

The present invention relates to a communication connection determination method, a communication connection determination device, and a sensor system, in a system that transmits and receives data acquired by a sensor.

### BACKGROUND

In the Internet of Things (IoT), a wide variety of sensors are connected to each other by wireless communication such as the Internet, and a large amount of data is collected and analyzed. In the sensor-related technology in the IoT, as illustrated in FIG. 8, in order to respond to various use cases and needs including healthcare, structure, and global environment monitoring, sensors 41_1 to 41_N and multi-connectable general-purpose sensor accommodating terminals 42_1 to 42_N have been used (Non Patent Literature 1).

In particular, in a case where data collection is performed by a sensor operating in an environment with limited resources, it is necessary to ascertain a network connection status of the sensor in order to avoid power waste due to data retransmission and unintended operation. As an index for ascertaining the connection status, a received signal strength indicator (RSSI) or the like is used as illustrated in FIG. 9.

In a connection between a data collection terminal slave device (sensor terminal) including a wide variety of sensors and a connectable general-purpose sensor accommodating terminal, there is a case where it is not possible to ensure network connection with excellent function and quality of a sensor terminal.

In particular, a state of connection between a sensor terminal and a sensor accommodating terminal depends on a communication environment according to a use case thereof. In a case where the communication environment is unstable, packet loss occurs in a random communication protocol. In this case, data is usually accumulated together with data retransmission.

As a result, under a connection environment where packet loss frequently occurs, the data accumulation speed is equal to or faster than the data transmission speed, and a memory amount of the sensor terminal becomes constrained.

This status is different from a status in which the connection between the sensor terminal and the sensor accommodating terminal is disconnected, and is a status in which packet loss occurs but a state does not shift to the disconnected state. Therefore, unless appropriate memory management is performed, there is a possibility of causing buffer overflow. Since the operation when the buffer overflow occurs is undefined, and there is a possibility that a serious failure occurs, it is necessary to prevent the status from occurring in advance.

Specifically, in the timeout method conventionally used under the above-described status, packets are received at intervals not exceeding a timeout time, and thus the connection between the sensor terminal and the sensor accommodating terminal is not disconnected. Given this, in order to prevent a failure due to the buffer overflow, it is necessary to avoid a status in which the packet loss continuously occurs.

Given this, it is necessary to ascertain a state of connection between the sensor terminal and the sensor accommodating terminal, and appropriately determine whether to continue or disconnect the connection to perform control according to the connection status.

Since a wide variety of sensor terminals are connected to the sensor accommodating terminal, it costs less to comprehensively perform the connection control in the sensor accommodating terminal than to perform the connection control in individual sensor terminals. In addition, comprehensively performing the connection control in the sensor accommodating terminal is more efficient because it is possible to implement a large number of deployed sensor terminals without updating firmware.

### CITATION LIST

### Non Patent Literature

Non Patent Literature 1: Kenichi Matsunaga, Shoichi Oshima, Ahmad Musa, Toshihiko Kondo, Hiroki Morimura, “Proposal of multi-sensor accommodation data collection technology suitable for IoT”, 2016 Institute of Electronics, Information and Communication Engineers, Communications Society Conference, B-18-56, Communications Lecture Proceedings 2, p. 420.
Non Patent Literature 2: Martin Woolley, “Bluetooth CoreSpecification v5.1”, ver.1.0.1, Bluetooth SIG, Inc., Dec. 9, 2020, pp. 1-12.

### SUMMARY

### Technical Problem

Disconnection in the connection between the sensor terminal and the sensor accommodating terminal can be determined by a received signal strength indicator (RSSI) which is a communication strength indicator illustrated in FIG. 9.

However, since the RSSI is a value obtained at a circuit level, a function needs to be supported in the communication circuit in advance.

Moreover, even if the function is supported, it is not necessarily information that can be accessed from an application side. This is because the pieces of information are deleted by a driver or an operating system (OS) up to an application that can be changed by a user, and this causes a similar problem in consideration of use of communication packet information described below.

Moreover, Bluetooth (registered trademark) Low Energy (BLE) is a standard used for communication between a sensor terminal and a sensor accommodating terminal. In the BLE, information available for preventing a buffer overflow from occurring is stored in a communication packet. This information is 1-bit information (MD Flag, More Data Flag) indicating the presence or absence of untransmitted data in a header in a data channel PDU. When using the information, the presence or absence of the remaining data can be ascertained, and therefore it can be used to avoid a buffer overflow.

However, there is a possibility that the MD flag will not be able to be accessed from the application side depending on the specifications of the driver of the OS (Non Patent Literature 2).

Given this, it is necessary to perform disconnection determination for avoiding buffer overflow from the sensor accommodating terminal by using information that can be accessed from the application side without using specific header information of the communication packet.

### Solution to Problem

In order to solve the above described problem, a communication connection determination method according to embodiments of the present invention is a communication connection determination method of determining a communication connection status between a sensor terminal and a sensor accommodating terminal, the method including: a step of receiving, by the sensor accommodating terminal, first data from the sensor terminal, and storing a first time stamp; a step of determining whether the reception number of pieces of the first data has reached a first specified number; a step of calculating a mean deviation reference value using a first time stamp interval obtained from the first time stamp in a case where the reception number of pieces of the first data has reached the first specified number; a step of receiving, by the sensor accommodating terminal, second data from the sensor terminal, and storing a second time stamp; a step of determining whether the reception number of pieces of the second data has reached a second specified number; a step of calculating a mean deviation evaluation value using a second time stamp interval obtained from the second time stamp in a case where the reception number of pieces of the second data has reached the second specified number; and a step of testing whether there is a significant difference between the mean deviation reference value and the mean deviation evaluation value, and determining that there is a communication connection abnormality when it is determined that there is a significant difference.

Also, the communication connection determination device according to embodiments of the present invention is a communication connection determination device that determines a communication connection status between a sensor terminal and a sensor accommodating terminal, the device including: a clock unit that measures an arrival time of data from the sensor terminal; a time stamp adding unit that acquires a time stamp on the basis of the arrival time; a memory that stores at least one of the time stamp and a time stamp interval obtained from the time stamp; and a disconnection determination unit that statistically determines a communication connection status between the sensor terminal and the sensor accommodating terminal, on the basis of the time stamp interval.

### Advantageous Effects of Embodiments of the Invention

According to embodiments of the present invention, it is possible to provide a communication connection determination method, a communication connection determination device, and a sensor system which determine communication connection in order to avoid buffer overflow.

### BRIEF DESCRIPTION OF THE DRAWINGS

FIG. 1 is a block diagram illustrating a configuration of a communication connection determination device and a sensor system according to a first embodiment of the present invention.

FIG. 2 is a block diagram illustrating a configuration of a connection determination unit in the communication connection determination device according to the first embodiment of the present invention.

FIG. 3 is a diagram for explaining an operation of the communication connection determination device and a communication connection determination method according to the first embodiment of the present invention.

FIG. 4 is a diagram for explaining the communication connection determination method according to the first embodiment of the present invention.

FIG. 5 is a diagram for explaining the communication connection determination method according to the first embodiment of the present invention.

FIG. 6 is a flowchart illustrating the communication connection determination method according to the first embodiment of the present invention.

FIG. 7 is a diagram for explaining the communication connection determination method according to the first embodiment of the present invention.

FIG. 8 is a block diagram illustrating a configuration of a communication connection determination device and a sensor system of the related art.

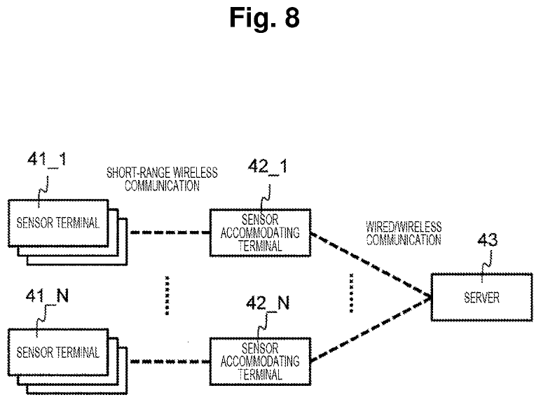

FIG. 9 is a diagram for explaining a communication connection determination method of the related art.

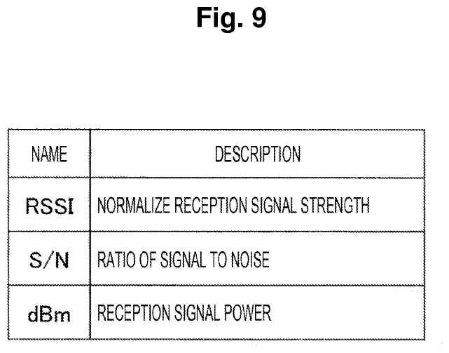

### DETAILED DESCRIPTION OF ILLUSTRATIVE EMBODIMENTS

### First Embodiment

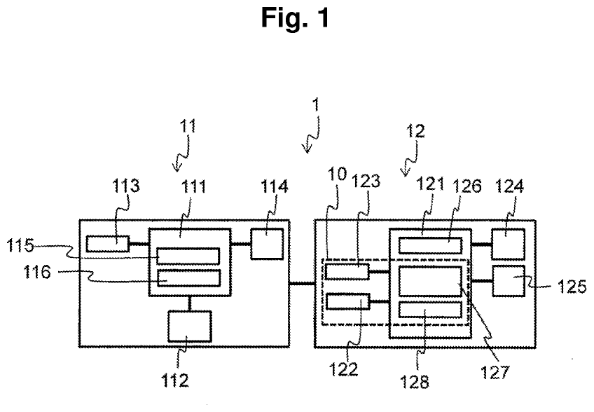

A determination device and a determination method according to a first embodiment of the present invention will be described with reference to FIGS. 1 to 7.

### Configuration of Sensor System and Determination Device

As illustrated in FIG. 1, a sensor system 1 according to the present embodiment includes a sensor terminal 11 and a sensor accommodating terminal 12.

The sensor terminal 11 includes a control unit 111, and a sensor circuit unit 112, a memory 113, and a wireless circuit 114 each of which are connected to the control unit 111.

The control unit 111 includes a CPU or an MCU, and includes a sensor control unit 115 and a communication control unit 116 which control the sensor circuit unit 112 and the wireless circuit 114, respectively.

Here, since an essential function of the sensor terminal 11 is to acquire data from the sensor circuit unit 112 and transmit the data to the sensor accommodating terminal 12 by wireless communication, the performance of the MPU of the control unit 111 may be low.

The sensor circuit unit 112 includes a sensor and acquires data.

The wireless circuit 114 transmits the data acquired by the sensor circuit unit 112 to the sensor accommodating terminal 12 as a packet.

The memory 113 holds (stores) a program and the acquired data until transmission.

The sensor accommodating terminal 12 includes a control unit 121, and a clock unit 122, a memory 123, a wireless circuit 124, and a communication circuit 125 each of which are connected to the control unit 121.

The control unit 121 includes a CPU or an MCU, and includes a communication control unit 126, a time stamp adding unit 127, and a disconnection determination unit 128.

Here, since the CPU or the MPU in the control unit 121 of the sensor accommodating terminal 12 needs to perform calculation processing, it is desirable to have a high calculation capability.

The communication control unit 126 controls the wireless circuit 124 and the communication circuit 125.

The wireless circuit 124 communicates with the sensor terminal 11 and receives data as a packet from the sensor terminal 11.

The communication circuit 125 communicates with a server and transmits data to the server as a packet.

The clock unit 122 includes a precision clock and measures an arrival time of the data from the sensor terminal 11.

The time stamp adding unit 127 acquires a time stamp on the basis of the arrival time measured by the clock unit 122.

The memory 123 holds (stores) the time stamp and the time stamp interval.

The disconnection determination unit 128 acquires a statistic from the time stamp interval and determines disconnection of communication between the sensor terminal 11 and the sensor accommodating terminal 12.

As described above, in the sensor system 1, the sensor terminal 11 acquires and collects data by the sensor, stores the data in the memory, and then wirelessly transmits the data to the sensor accommodating terminal 12.

On the other hand, the sensor accommodating terminal 12 receives the data transmitted from the sensor terminal 11, measures the arrival time of the received packet (data) by the clock unit 122, acquires the time stamp on the basis of the time by the time stamp adding unit 127, calculates and acquires the time stamp interval, and stores the time stamp interval in the memory 123.

The mean deviation is obtained by calculation from the time stamp interval and used as a reference value. In addition, the mean deviation is acquired by calculation from a plurality of newly obtained time stamp intervals, and is used as an evaluation value.

The disconnection determination unit 128 determines disconnection of the communication connection on the basis of the time-stamped data.

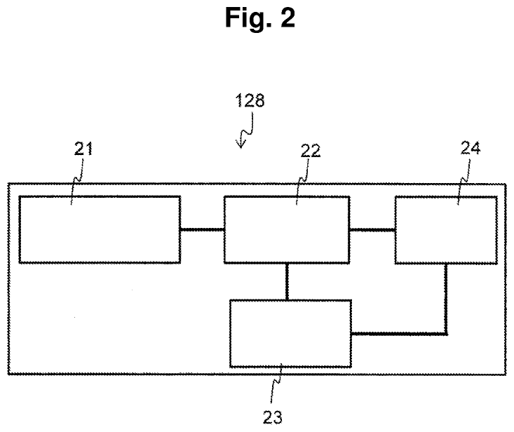

As illustrated in FIG. 2, the disconnection determination unit 128 includes a time stamp interval input unit 21, a mean deviation calculation unit 22, a storage unit 23, and a test determination unit 24.

The time stamp interval is input to the time stamp interval input unit 21 on the basis of the time stamp acquired from the data.

The mean deviation calculation unit 22 calculates a mean deviation reference value and a mean deviation evaluation value on the basis of the time stamp interval.

The calculated mean deviation reference value and mean deviation evaluation value are stored in the storage unit 23.

The test determination unit 24 determines whether to disconnect (maintain) the communication connection on the basis of the calculated mean deviation reference value and mean deviation evaluation value.

Here, the mean deviation reference value calculated in the storage unit may be stored, and the test determination unit 24 may perform the determination on the basis of the stored mean deviation reference value and the mean deviation evaluation value calculated by the mean deviation calculation unit.

In the sensor system 1 according to the present embodiment, a determination device 10 includes a clock unit 122, a memory 123, a time stamp adding unit 127, and a disconnection determination unit 128.

### Determination Method

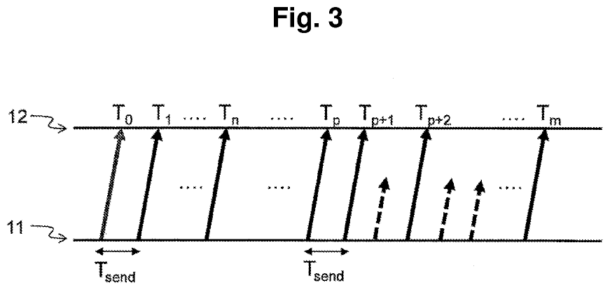

The determination method according to the present embodiment will be described with reference to FIGS. 3 to 6.

First, data transmission and reception between the sensor terminal 11 and the sensor accommodating terminal 12 will be described. As illustrated in FIG. 3, the sensor terminal 11 transmits data (packet) storing data acquired from the sensor circuit unit 112 at a constant period T_{send} to the sensor accommodating terminal 12. On the other hand, the sensor accommodating terminal 12 acquires a time stamp when receiving the packet from the sensor terminal 11 and stores the time stamp in the memory 123.

In this case, the expected value E[dₙ] of the time interval dₙ₋₁ between two consecutive time stamps Tₙ₋₁ and Tₙ is expressed by Formulas (1) and (2).

$$\begin{matrix}Equation 1 & \\ {d}_{n - 1} = {{T}^{}}_{n} - {T}_{n - 1} & ( 1 )\end{matrix}$$

$$\begin{matrix}Equation 2 & \\ E [ {d}_{n} ] = {{T}^{}}_{send} & ( 2 )\end{matrix}$$

Here, the expected value E[dₙ] of the time interval dₙ₋₁ coincides with the transmission period T_{send}.

In communication using the sensor system 1, when data transfer is delayed due to packet loss (for example, in the drawing, a dotted arrow) or the like, the time stamp interval dₙ₋₁ is longer than T_{send} (for example, in the drawing, Tₚ₊₁ to Tₚ₊₂). In this manner, each time stamp varies with respect to an expected value depending on a communication status.

Here, when the communication status is determined, each time stamp randomly varies with respect to the expected value, but there is a possibility that the time stamp does not have a normal distribution depending on a wireless communication environment. In this case, there are more outliers than the normal distribution, and the deviation may be detected to be large, and the communication status cannot be accurately monitored.

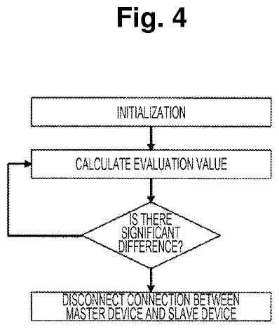

In this case, in order to ensure robustness against the outlier, the median value in robust statistics is effective as the evaluation value. The mean deviation is useful as a value representing variation with respect to the median value, and it is possible to perform abnormality determination by evaluating the median value and the mean deviation even in a communication environment with a large outlier. For example, as illustrated in FIG. 4, after initialization, when a median value and a mean deviation are calculated as evaluation values and an abnormality is determined, the connection between the sensor accommodating terminal 12 and the sensor terminal 11 is disconnected.

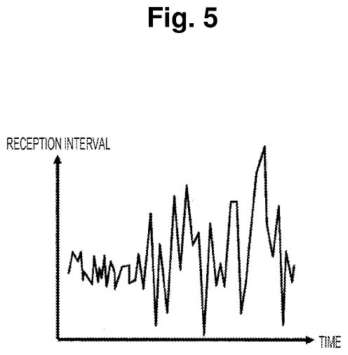

However, in a case where communication protocols are different, when data transfer by communication is delayed due to packet loss or the like, data may be transmitted at an interval earlier than a predetermined transmission interval T_{send}. In this case, as illustrated in FIG. 5, even if the communication environment deteriorates, there is a possibility that only the mean deviation changes without changing the median value of the reception intervals.

For example, in BLE, which is a communication protocol in the sensor terminal 11, communication is performed only at a connection interval specified at the time of connection, and in a case where an event to send data occurs in the sensor terminal 11, transmission is attempted at a connection interval immediately after occurrence of the event.

This connection interval is generally shorter than the data transmission interval T_{send}. As a result, in a case where transmission or reception fails, retransmission is attempted at a next connection interval, and thus, there is a possibility that a time stamp interval shorter than T_{send} is recorded.

Therefore, in the present embodiment, as described below, the sensor accommodating terminal 12 determines connection with the sensor terminal 11 using only the mean deviation instead of the median value.

In the determination method according to the present embodiment, a change in a representative value (mean deviation) from data in which an outlier is expected and the same population is evaluated. Specifically, the presence or absence of a significant difference between the reference value of the mean deviation of the time stamp intervals and the evaluation value is tested. Therefore, in the determination method, a Wilcoxon signed-rank test capable of testing a significant difference between representative values of two groups having correspondence is used instead of the normal distribution.

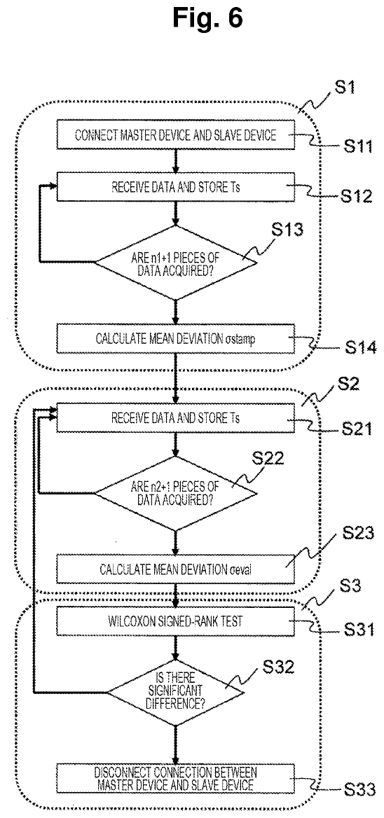

FIG. 6 is a flowchart illustrating a determination method according to the present embodiment.

First, the connection between the sensor accommodating terminal 12 (master device) and the sensor terminal (slave device) 11 is initialized (step S1).

First, the sensor terminal 11 is connected to the sensor accommodating terminal 12 (step S11).

Next, the packet (data) is received and the time stamp is stored (step S12).

Subsequently, reception of data and storage of the time stamp are repeated, and a predetermined number (for example, n₁+1) of pieces of data and time stamps are acquired. Specifically, the reception number of pieces of the data is counted to determine whether the reception number has reached a specified number, and data is received until the reception number reaches the specified number (step S13).

Next, a mean deviation as a reference value (hereinafter, referred to as “mean deviation reference value”) σₛₜₐₘₚ is calculated using n₁ time stamp intervals d_{1,i} by Formulas (3) and (4) (step S14).

$$\begin{matrix}Equation 3 & \\ {{T}^{′}}_{send} = \frac{1}{{n}_{1}} \{ {\sum }_{i = 1}^{{n}_{1}} {d}_{1 , i} \} & ( 3 )\end{matrix}$$

$$\begin{matrix}Equation 4 & \\ {σ}_{stamp} = \frac{1}{{n}_{1} - 1} \{ {\sum }_{i = 1}^{{n}_{1}} \vert {d}_{1 , i} - {{T}^{′}}_{send} \vert \} & ( 4 )\end{matrix}$$

Next, the evaluation value is calculated (step S2).

First, data is received and a time stamp is stored (step S21).

Subsequently, reception of data and storage of the time stamp are repeated, and a predetermined number (for example, n₂+1) of pieces of data and time stamps are acquired. Specifically, the reception number of pieces of the data is counted to determine whether the reception number has reached a specified number, and data is received until the reception number reaches the specified number (step S22).

Next, the mean deviation evaluation value σₑᵥₐₗ is calculated using n₂ time stamp intervals d_{1,i} by Formulas (5) and (6) (step S23).

$$\begin{matrix}Equation 5 & \\ {{T}^{′}}_{send} = \frac{1}{{n}_{2}} \{ {\sum }_{i = 1}^{{n}_{1}} {d}_{2 , i} \} & ( 5 )\end{matrix}$$

$$\begin{matrix}Equation 6 & \\ {σ}_{eval} = \frac{1}{{n}_{2} - 1} \{ {\sum }_{i = 1}^{{n}_{2}} \vert {d}_{2 , i} - {{T}^{′}}_{send} \vert \} & ( 6 )\end{matrix}$$

Next, presence or absence of a significant difference between the mean deviation reference value and the mean deviation evaluation value is determined, and connection is disconnected (step S3).

Next, the presence or absence of the significant difference between the mean deviation reference value and the mean deviation evaluation value is determined at a significance level a by a Wilcoxon signed-rank test (step S31).

In the Wilcoxon signed-rank test, in a case where it is determined that there is a significant difference, it is determined (decided) that the connection is abnormal, and the connection between the sensor accommodating terminal 12 and the sensor terminal 11 is disconnected (Steps S32 to S33).

In addition, in a case where it is determined that there is no significant difference, it is determined (decided) that the connection is normal, and the connection between the sensor accommodating terminal 12 and the sensor terminal 11 is maintained (step S32).

According to the above method, it is possible to recognize a significant difference in mean deviation between a normal state and an abnormal state in the connection between the sensor accommodating terminal 12 and the sensor terminal 11, and a user can randomly set a level (significance level) and determine disconnection of connection. Here, it is desirable that n₁ is set to n₂ or more in order to determine disconnection with less temporal loss after calculation of the reference value.

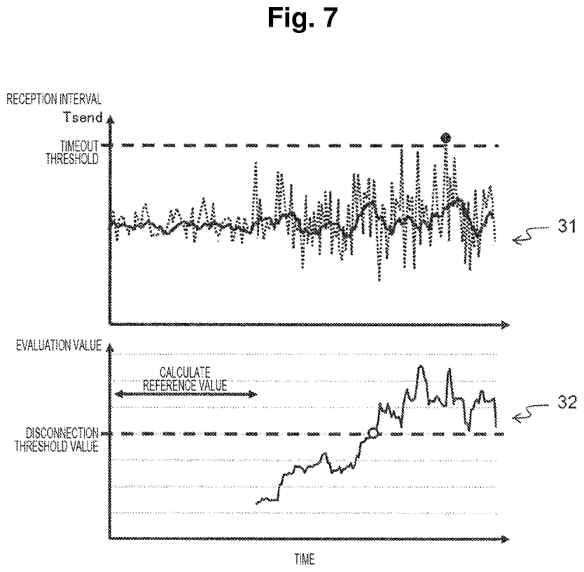

FIG. 7 is a schematic diagram 31 of a change in a reception interval and a schematic diagram 32 of a change in a test evaluation value in the determination method according to the present embodiment. The schematic diagram 31 illustrates a reception interval (dotted line), a mean value of the reception intervals (solid line), and a timeout threshold (broken line). In addition, the schematic diagram 32 illustrates an evaluation value (solid line) and a disconnection threshold value (broken line).

In the disconnection determination by timeout in a conventional method, as illustrated in the schematic diagram 31, since the determination is made at the reception interval, it is necessary to set an appropriate threshold. For example, when the reception interval (dotted line) exceeds the timeout threshold (broken line), it is determined that the connection is abnormal (black circle in the drawing). As a result, in a case where an appropriate threshold is not set, there is a possibility that connection is not disconnected or disconnection frequently occurs.

In the present embodiment, as illustrated in the schematic diagram 32, a reference value is calculated in advance (initialized), and when the evaluation value (test value) exceeds the disconnection threshold, it is determined that the connection is abnormal (white circle in the drawing).

In this manner, by performing communication disconnection by determining on the basis of the evaluation value obtained by evaluating (testing) whether or not the mean deviations of two groups having no normal distribution are equal, it is possible to identify instability of a communication environment from variation in reception intervals and perform disconnection processing.

Moreover, as a result, an abnormal operation can be prevented in advance, and after disconnection, buffer overflow can be avoided as a connection standby state, and an operation of the sensor terminal 11 can be continued.

As a result, it is possible to cope with differences in communication specifications and designs of various sensor terminals 11 at low cost on a sensor accommodating terminal 12 side, and it is possible to improve stability as a sensor system including the sensor accommodating terminal and the sensor terminal.

In particular, it is particularly effective for a communication protocol in which retransmission, that is, burst transmission, is performed at a higher speed than a predetermined transmission interval when there is untransmitted data.

In addition, in a case where an absolute value calculation, an addition or subtraction, and an average processing are used for the calculation of the mean deviation, since necessary calculation resources in a computer are smaller than those in a calculation of a variance accompanied by the integration such as a square calculation, it is effective for reducing a calculation amount and reducing a power consumption as compared with abnormality determination using the variance.

### Second Embodiment

### Configuration of Sensor System and Determination Device

The determination method and the determination device according to the present embodiment can operate in a configuration including a plurality of sensor terminals 11 while being operable in a configuration including a single or a plurality of sensor terminals in the first embodiment. The other configurations are the same as those of the first embodiment.

### Determination Method

In the first embodiment, the σₛₜₐₘₚ is calculated in an initial state in the connection between the sensor accommodating terminal and the sensor terminal and used as the reference value. Therefore, in a case where the communication environment is poor immediately after the start of the connection, the sensor accommodating terminal cannot receive a packet from the sensor terminal (for example, a slave device A) at a normal communication interval, and thus cannot accurately acquire the σₛₜₐₘₚ.

Given this, the mean deviation reference value σₛₜₐₘₚ is calculated using data from a sensor terminal that can normally communicate, other than the slave device A.

Here, in a case where the communication interval T_{send} of each sensor terminal is compared with the time stamp interval of data received from each sensor terminal, and the communication interval T_{send} is equal to or less than a predetermined value, the sensor terminal is selected as a sensor terminal that can normally communicate.

Thereafter, determination is performed in the same manner as in the first embodiment, using the selected sensor terminal.

### Advantageous Effects

In the determination device according to the present embodiment, when there are S sensor terminals, the respective communication intervals are T_{send}ⁱ, and the number of pieces of data used for initialization is M, time τ required for initialization, that is, acquisition of the mean deviation reference value is expressed by Formula (7) in a case where the communication intervals are all the same (T_{send}ⁱ=T_{send}).

$$\begin{matrix}Equation 7 & \\ τ = ⌈ \frac{M}{S} ⌉ {T}_{send} & ( 7 )\end{matrix}$$

Here, when the number M of pieces of data is a multiple of the number S of sensor terminals, initialization data can be collected most efficiently.

In addition, the time t in a case where the communication intervals are different among the sensor terminals is expressed by Formula (8).

$$\begin{matrix}Equation 8 & \\ τ \approx \frac{M}{{Σ}_{i = 1}^{S} \frac{1}{{T}_{send}^{i}}} & ( 8 )\end{matrix}$$

As described above, according to the present embodiment, since the time t is equal to or less than T_{send}, the time required for initialization, that is, acquisition of the mean deviation reference value can be shortened. Therefore, the determination regarding the communication disconnection can be accelerated, and a real-time property is improved.

In the embodiments of the present invention, examples of structures, dimensions, materials, and the like of the respective components have been described above in relation to the configurations, determination method, and the like of the communication connection determination device and the sensor system. However, the present invention is not limited thereto. Any embodiment may be used as long as functions and effects of the communication connection determination device, the sensor system, and the determination method are exhibited.

### INDUSTRIAL APPLICABILITY

Embodiments of the present invention can be applied to determination of a communication status in an IoT network using a sensor.

1-8. (canceled)

9. A communication connection determination method, the method comprising:
receiving, by a sensor accommodating terminal, first data from a sensor terminal, and storing a first time stamp;
determining whether a reception number of pieces of the first data has reached a first specified number;
calculating a mean deviation reference value using a first time stamp interval obtained from the first time stamp in response to a determination that the reception number of pieces of the first data has reached the first specified number;
receiving, by the sensor accommodating terminal, second data from the sensor terminal, and storing a second time stamp;
determining whether a reception number of pieces of the second data has reached a second specified number;
calculating a mean deviation evaluation value using a second time stamp interval obtained from the second time stamp in response to a determination that the reception number of pieces of the second data has reached the second specified number; and
testing whether there is a threshold difference between the mean deviation reference value and the mean deviation evaluation value and determining that there is a communication connection abnormality in response to a determination that there is the threshold difference.

10. The method according to claim 9, wherein testing whether there is the threshold difference comprises testing for a presence or an absence of the threshold difference by a Wilcoxon signed-rank test.

11. The method according to claim 10, wherein the mean deviation reference value satisfies equation (A) and equation (B) below, wherein the mean deviation evaluation value satisfies equation (C) and equation (D) below,
$${{T}^{′}}_{send} = \frac{1}{{n}_{1}} \{ {\sum }_{i = 1}^{{n}_{1}} {d}_{1 , i} \} \qquad ( A )$$
$${σ}_{stamp} = \frac{1}{{n}_{1} - 1} \{ {\sum }_{i = 1}^{{n}_{1}} \vert {d}_{1 , i} - {{T}^{′}}_{send} \vert \} \qquad ( B )$$
$${{T}^{′}}_{send} = \frac{1}{{n}_{2}} \{ {\sum }_{i = 1}^{{n}_{1}} {d}_{2 , i} \} \qquad ( C )$$
$${σ}_{eval} = \frac{1}{{n}_{2} - 1} \{ {\sum }_{i = 1}^{{n}_{2}} \vert {d}_{2 , i} - {{T}^{′}}_{send} \vert \} \qquad ( D )$$
and wherein d_{1,i} represents the first time stamp interval, n₁ represents the reception number of pieces of the first data, σₛₜₐₘₚ represents the mean deviation reference value, d_{2,i} represents the second time stamp interval, n₂ represents the reception number of pieces of the second data, and σₑᵥₐₗ is the mean deviation evaluation value.

12. The method according to claim 11, wherein:
the sensor terminal is provided in plural;
the method further comprises selecting a first sensor terminal from the plural sensor terminals as a normally communicating sensor terminal based on a communication interval of each of the plural sensor terminals and a time stamp interval of each piece of data received from the plural sensor terminals; and
the first data is received from the first sensor terminal.

13. The method according to claim 9, wherein the mean deviation reference value satisfies equation (A) and equation (B) below, wherein the mean deviation evaluation value satisfies equation (C) and equation (D) below,
$${{T}^{′}}_{send} = \frac{1}{{n}_{1}} \{ {\sum }_{i = 1}^{{n}_{1}} {d}_{1 , i} \} \qquad ( A )$$
$${σ}_{stamp} = \frac{1}{{n}_{1} - 1} \{ {\sum }_{i = 1}^{{n}_{1}} \vert {d}_{1 , i} - {{T}^{′}}_{send} \vert \} \qquad ( B )$$
$${{T}^{′}}_{send} = \frac{1}{{n}_{2}} \{ {\sum }_{i = 1}^{{n}_{1}} {d}_{2 , i} \} \qquad ( C )$$
$${σ}_{eval} = \frac{1}{{n}_{2} - 1} \{ {\sum }_{i = 1}^{{n}_{2}} \vert {d}_{2 , i} - {{T}^{′}}_{send} \vert \} \qquad ( D )$$
and wherein d_{1,i} represents the first time stamp interval, n₁ represents the reception number of pieces of the first data, σₛₜₐₘₚ represents the mean deviation reference value, d_{2,i} represents the second time stamp interval, n₂ represents the reception number of pieces of the second data, and σₑᵥₐₗ is the mean deviation evaluation value.

14. The method according to claim 9, wherein:
the sensor terminal is provided in plural;
the method further comprises selecting a first sensor terminal from the plural sensor terminals as a normally communicating sensor terminal based on a communication interval of each of the plural sensor terminals and a time stamp interval of each piece of data received from the plural sensor terminals; and
the first data is received from the first sensor terminal.

15. A communication connection determination device, the device comprising:
one or more processors; and
a storage device storing a program to be executed by the one or more processors, the program including instructions for:
measuring an arrival time of data from a sensor terminal;
acquiring a time stamp based on the arrival time;
storing the time stamp or a time stamp interval obtained from the time stamp; and
statistically determining a communication connection status between the sensor terminal and a sensor accommodating terminal based on the time stamp interval.

16. The device according to claim 15, wherein the program further includes instructions for:
receiving the time stamp interval;
calculating a mean deviation reference value and a mean deviation evaluation value based on the time stamp interval;
storing the mean deviation reference value; and
determining whether to disconnect a communication connection based on the mean deviation reference value and the mean deviation evaluation value.

17. The device according to claim 16, wherein the sensor terminal is provided in plural, and wherein the program further includes instructions for selecting a first sensor terminal of the plural sensor terminals as a normally communicating sensor terminal based on a communication interval of each of the plural sensor terminals and a time stamp interval of each piece of data received from the plural sensor terminals.

18. The device according to claim 15, wherein the sensor terminal is provided in plural, and wherein the program further includes instructions for selecting a first sensor terminal of the plural sensor terminals as a normally communicating sensor terminal based on a communication interval of each of the plural sensor terminals and a time stamp interval of each piece of data received from the plural sensor terminals.

19. A sensor system comprising:
a sensor terminal; and
a sensor accommodating terminal comprising a communication connection determination device, the communication connection determination device comprising:
one or more processors; and
a storage device storing a program to be executed by the one or more processors, the program including instructions for:
measuring an arrival time of data from a sensor terminal;
acquiring a time stamp based on the arrival time;
storing the time stamp or a time stamp interval obtained from the time stamp; and
statistically determining a communication connection status between the sensor terminal and a sensor accommodating terminal based on the time stamp interval.

20. The sensor system according to claim 19, wherein the program further includes instructions for:
receiving the time stamp interval;
calculating a mean deviation reference value and a mean deviation evaluation value based on the time stamp interval;
storing the mean deviation reference value; and
determining whether to disconnect a communication connection based on the mean deviation reference value and the mean deviation evaluation value.

21. The sensor system according to claim 20, wherein the sensor terminal is provided in plural, and wherein the program further includes instructions for selecting a first sensor terminal of the plural sensor terminals as a normally communicating sensor terminal based on a communication interval of each of the plural sensor terminals and a time stamp interval of each piece of data received from the plural sensor terminals.

22. The sensor system according to claim 19, wherein the sensor terminal is provided in plural, and wherein the program further includes instructions for selecting a first sensor terminal of the plural sensor terminals as a normally communicating sensor terminal based on a communication interval of each of the plural sensor terminals and a time stamp interval of each piece of data received from the plural sensor terminals.
